(19) United States
(12) Patent Application Publication
(10) Pub. No.: US 2009/0237577 A1
(43) Pub. Date: Sep. 24, 2009

(54) ELECTRONIC DEVICE AND INPUT DEVICE THEREOF

(75) Inventors: FEI GAO, Shenzhen City (CN); WEN-HAW TSENG, Tu-Cheng (TW); LI LI, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO. LTD., ShenZhen City (TW); HON HAI PRECISION INDUSTRY CO., LTD., Tu-Cheng (TW)

(21) Appl. No.: 12/325,275

(22) Filed: Dec. 1, 2008

(30) Foreign Application Priority Data
Mar. 21, 2008 (CN) 200810300654.0

(51) Int. Cl. G02F 1/1333; G06F 3/041

(52) U.S. Cl. 349/23; 345/173

(57) ABSTRACT

An exemplary input device includes a key. The key includes a first conductive film, a second conductive film, a light source, a photoelectric transformer, and a liquid crystal layer. The second conductive film is configured for cooperating with the first conductive film to generate a first electric field having a first predetermined intensity when the key is pressed. The light source is configured for emitting light. The photoelectric transformer is configured for generating a first electric signal when receiving the light from the light source. The liquid crystal layer is configured for transmitting the light to the photoelectric transformer under influence of the first electric field. A related electronic device is also provided.

### BACKGROUND

1. Technical Field

The present disclosure relates to an input device for electronic devices.

2. Description of Related Art

Input devices, such as keyboards and touchscreens are widely used for inputting information into microprocessors or other similar semiconductor circuits. There are several types of keyboards available, such as mechanical keyboards, membrane/film keyboards, and virtual keyboards.

A mechanical keyboard adopts an individual keyswitch mechanism for each key. However, to generate a keystroke, more force is needed to actuate the mechanical key than using the membrane keyboards. This may result in carpal tunnel syndrome for the user's wrists after an extended period of use of the mechanical keyboard. Furthermore, most mechanical keys generate a clicking sound when the key is actuated, and this may disturb others in close quarters.

Membrane keyboards are by far the most commonly used with computers and all kinds of portable electronic devices. They are designed so that all keycaps are positioned above rubber domes. Each rubber dome is above a 3-layer plastic membrane that spreads over the entire keyboard. The membrane keyboards produce no audible click when pressed, and need a lighter touch than mechanical keyboards. However, some keys become inelastic and other overly elastic because of buildup of debris, rubber fatigue, manufacturing imperfections and even ultraviolet radiation after a long time use. This creates a variance in how much force is required to actuate each key on the keyboard.

A touchscreen is a display which can detect the presence and location of a touch within the display area. Touchscreens can also sense other passive objects, such as a stylus. As input devices, the touchscreens do not have the aforementioned deficiency and inadequacies in the mechanical keyboards and membrane keyboards. However, new type input devices are also desired.

Therefore, it is desired to provide a new input device having similar figure and advantages of a touchscreen.

Other advantages and novel features of the present invention will become more apparent from the following detailed description of an embodiment/embodiments when taken in conjunction with the accompanying drawings.

### BRIEF DESCRIPTION OF THE DRAWINGS

FIG. 1 is a schematic diagram of an electronic device in accordance with an exemplary embodiment, the electronic device includes an input device having a plurality of keys.

FIG. 2 is a block diagram of one of the plurality of keys of FIG. 1 in accordance with a first exemplary embodiment.

FIG. 3 is a schematic circuit diagram of one of the plurality of keys of FIG. 1.

FIG. 4 is a block diagram of a key in an input device in accordance with a second exemplary embodiment.

FIG. 5 is a block diagram of an input device in accordance with a third exemplary embodiment.

### DETAILED DESCRIPTION

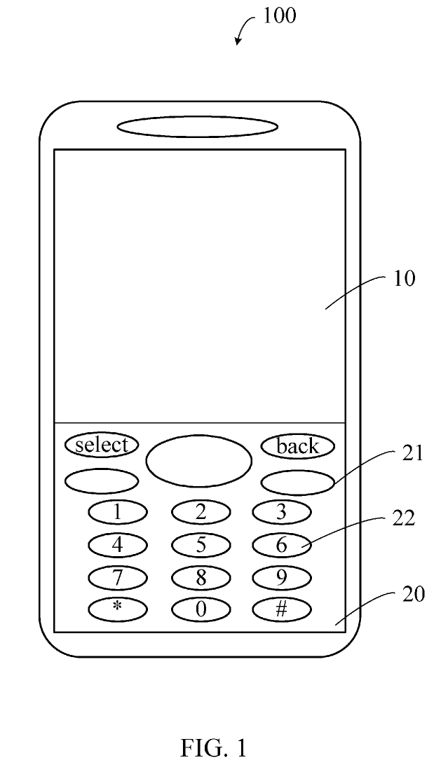

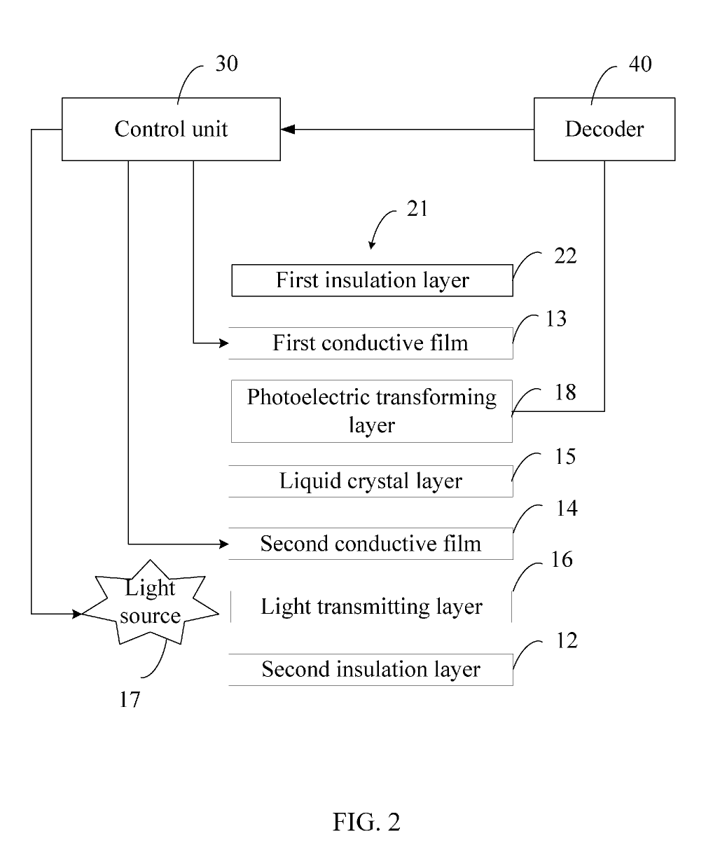

Referring to FIGS. 1 and 2, an electronic device 100 in accordance with an exemplary embodiment includes a display 10, an input device 20, and a control unit 30. The electronic device 100 is shown as a mobile phone in FIG. 1, however, it may also be an automatic teller machine (ATM), a computer, a personal digital assistant, or a navigation device, etc.

The display 10 is configured for displaying information.

The input device 20 includes a plurality of keys 21 for receiving pressing operations and generating first electrical signals correspondingly. The input device 20 further includes a decoder 40 for decoding the first electrical signals, and generating second electrical signals corresponding to the first electrical signals. The first electrical signals generated by each of the plurality of keys 21 are the same, while the second electrical signals generated by the decoder 40 are different according to the plurality of keys 21. The second electrical signals are recognizable by the control unit 30, and are used for identifying each of the plurality of keys 21. In the embodiment, each of the plurality of keys 21 has a similar structure. Thus, only one of the plurality of keys 21 is described below.

The key 21 includes seven layers and a light source 17. The seven layers include a first insulation layer 22, a second insulation layer 12, a first conductive film 13, a second conductive film 14, a liquid crystal layer 15, a light transmitting layer 16, and a photoelectric transforming layer 18.

The first insulation layer 22 is disposed on top of the key 21 as a touch layer. The first conductive film 13, the photoelectric transforming layer 18, the liquid crystal layer 15, the second conductive film 14, the light transmitting layer 16, and the second insulation layer 12 are disposed underneath the first insulation layer 22 in a sequential order.

The first and second insulation layers 22, 12 may be made of colophony, plastic, glass, or rubber material. In the embodiment, the first insulation layer 22 is made of opaque colophony material, such that external light cannot be transmitted into the key 21. There are one or more key identification characters, such as “1” or “select”, engraved or printed on the first insulation layer 22.

The first conductive film 13 is configured for cooperating with the second conductive film 14 to generate an electric field with a voltage applied thereto. When the key 21 is fully pressed, a first electric field having a first predetermined intensity is generated. When the key 21 is not pressed or released, a second electric field having a second predetermined intensity is generated. The second predetermined intensity of the second electric field is lower than the first predetermined intensity of the first electric field. The first conductive film 13 and the second conductive film 14 may be both coated with a conductive material (for example, indium tin oxide material, ITO material) that conducts a continuous electrical current across the films. It is known that not only can the ITO material conduct electrical current, but also is transparent to light.

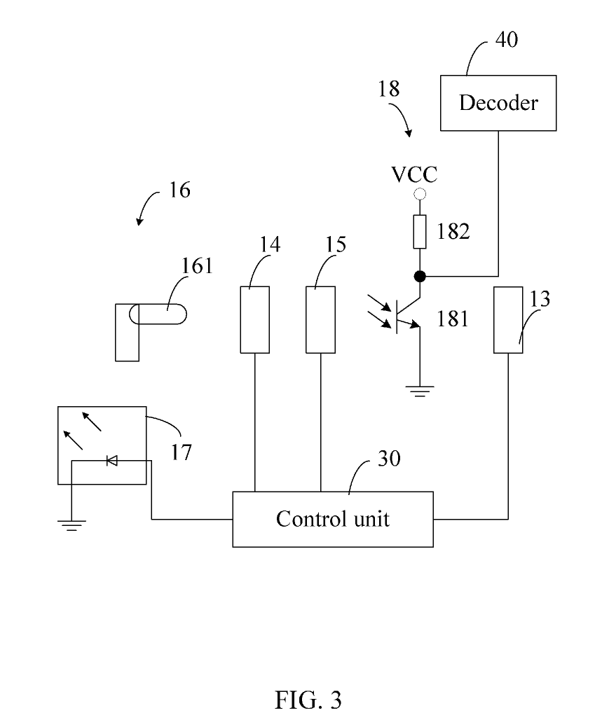

The light source 17 is disposed adjacent to the light transmitting layer 16. The light source 17 may be any type of mini-light sources, such as a light-emitting diode (LED). The light transmitting layer 16 includes one or more light conduits 161 (refer to FIG. 3) for transmitting light emitted from the light source 17 through the second conductive film 14 to the liquid crystal layer 15. Thus, the second conductive film 14 should be transparent. The liquid crystal layer 15 may be made of any type of liquid crystal molecule, such as twisted nematic (TN), super twisted nematic (STN), or dual scan tortuosity nomograph (DSTN) molecule. The liquid crystal layer 15 is configured for transmitting light from the light source 17 to the photoelectric transforming layer 18 under the influence of the first electric field. The second predetermined intensity of the second electric field is not enough to influence the liquid crystal layer 15 to transmit light. The photoelectric transforming layer 18 is configured for transforming light to generate the first electric signal when receiving light from the liquid crystal layer 15.

Referring also to FIG. 3, the photoelectric transforming layer 18 may include at least a photoelectric transformer 181, such as a phototransistor. In the embodiment, the photoelectric transforming layer 18 includes a phototransistor (also labeled as 181). An emitter of the phototransistor 181 is grounded, a collector of the phototransistor 181 is connected to a power supply VCC via a resistor 182. The collector of the phototransistor 181 is also connected to the decoder 40.

During operation, when the key 21 is not pressed, light emitted by the light source 17 is blocked by the liquid crystal layer 15 and is not transmitted to the phototransistor 181. The phototransistor 181 is off and the voltage at the decoder 40 is VCC. The decoder 40 has no output, or an output of the decoder 40 is not changed. When the key 21 is pressed, the first conductive film 13 moves closer to the second conductive film 14 and at a predetermined distance between the first and second conductive films 13, 14, the second electric field is increased to the first predetermined intensity. The liquid crystal layer 15 is influenced by the first electric field to transmit light. Thus, light emitted by the light source 17 travels to the phototransistor 181 via the liquid crystal layer 15. As a result, the phototransistor 181 is turned on, and a voltage at the collector of the phototransistor 181 is pulled to ground. Thus, the decoder 40 is at 0 volts, and the decoder generates the second electric signal that is recognizable by the control unit 30.

The control unit 30 is configured for controlling the information that is displayed on the display 10, powering the input device 20, and receiving and processing the second electric signal(s) according to predetermined programs. The first and second conductive films 13, 14, and the light source 17 may be connected to and powered by the control unit 30. The control unit 30 may supply a first predetermined voltage to the first and second conductive films 13, 14, so as to generate the second electric field having the second predetermined intensity.

To sum up, the key 21 is actuated by pressing the first insulation layer 22 to push the first conductive film 13 toward the second conductive film 14. This will produce no audible click, and requires a force that is lighter than that of mechanical keys.

In the embodiment, the plurality of keys 21 may contain separate liquid crystal layers 15 and photoelectric transforming layer 18 for individual keys 21, but other layers of the seven layers of the plurality of keys 21 may form essentially uniform layers. In other words, the plurality of keys 21 may share a piece of the first insulation layer 22, a piece of the second insulation layer 12, a piece of the first conductive film 13, a piece of the second conductive film 14, and a piece of the light transmitting layer 16. For example, a first key of the plurality of keys 21 may utilize a first section of the first insulation layer 22, a first section of the second insulation layer 12, a first section of the first conductive film 13, a first section of the second conductive film 14, and a first section of the light transmitting layer 16. And a second key of the plurality of keys 21 may utilize a second section of the first insulation layer 22, a second section of the second insulation layer 12, a second section of the first conductive film 13, a second section of the second conductive film 14, and a second section of the light transmitting layer 16. Other layers may be shared in a similar manner. Thus, the input device 20 can be easily integrated to form a part of a casing of the electronic device 100. Furthermore, the input device 20 is useful particularly in applications where the electronic device 100 and the input device 20 must be inside a compact casing in order to be water or dust resistance, for instance.

In other embodiments, the input device 20 may only include one or more light sources 17. Light emitted by the one or more light sources 17 travels to the plurality of keys 21 via the light transmitting layer 16. The first insulation layer 22 may be transparent or semitransparent, and the position of the one or more key identification characters on the first insulation layer 22 coincides with the position of the photoelectric transformer 181, such that external light is blocked by the one or more characters and cannot travel to the photoelectric transformer 181.

In other embodiments, positions of the photoelectric transforming layer 18 and the first conductive film 13 can be exchanged, and positions of the light transmitting layer 16 and the second conductive film 14 can be exchanged. The input device 20 may further include another light transmitting layer, disposed between the photoelectric transforming layer 18 and the liquid crystal layer 15. The another light transmitting layer is configured for transmitting light from the liquid crystal layer 15 to corresponding photoelectric transformer 181 of the photoelectric transforming layer 18. In other embodiments, the input device 20 may include only one key 21.

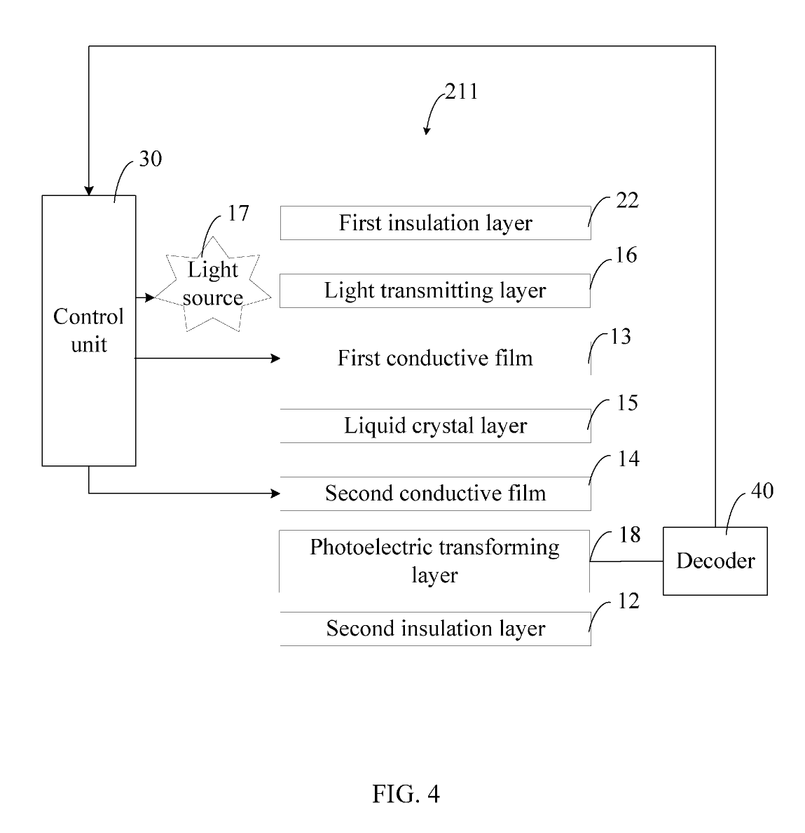

Referring to FIG. 4, a key 211 of an input device in accordance with a second exemplary embodiment is illustrated. Similar to the key 21, the key 211 includes the seven layers and the light source 17. The seven layers include the first insulation layer 22, the light transmitting layer 16, the first conductive film 13, the liquid crystal layer 15, the second conductive film 14, the photoelectric transforming layer 18, and the second insulation layer 12 which are disposed in a sequential order.

In the embodiment, the first insulation layer 22, the first conductive film 13, and the second conductive film 14 are transparent. There is no key identification character(s) engraved or printed on the first insulation layer 22. The key identification character(s) is (are) displayed by the liquid crystal layer 15. Thus, an appearance of the key 211 may be more appealing or attractive than that of the key 21. Position of the key identification character(s) displayed and position of the photoelectric transformer 181 of the photoelectric transforming layer 18 are staggered, such that the photoelectric transformer 181 is not turned on by the light of the key identification character(s).

Similar to the key 21, the key 211 is actuated, that is, the first electric signal is generated, when the key 211 is pressed. When the key 211 is not pressed, light emitted by the light source 17 is blocked by the liquid crystal layer 15 and cannot travel to the photoelectric transformer 181. There is no first electric signal, and the output of the decoder 40 is unchanged, that is, VCC.

In alternative embodiments, the positions of the photoelectric transforming layer 18 and the second conductive film 14 can be exchanged, and the positions of the light transmitting layer 16 and the first conductive film 13 can be exchanged. The key 211 may further include another light transmitting layer, disposed between the photoelectric transforming layer 18 and the liquid crystal layer 15, for transmitting light from the liquid crystal layer 15 to corresponding photoelectric transformer 181 of the photoelectric transforming layer 18.

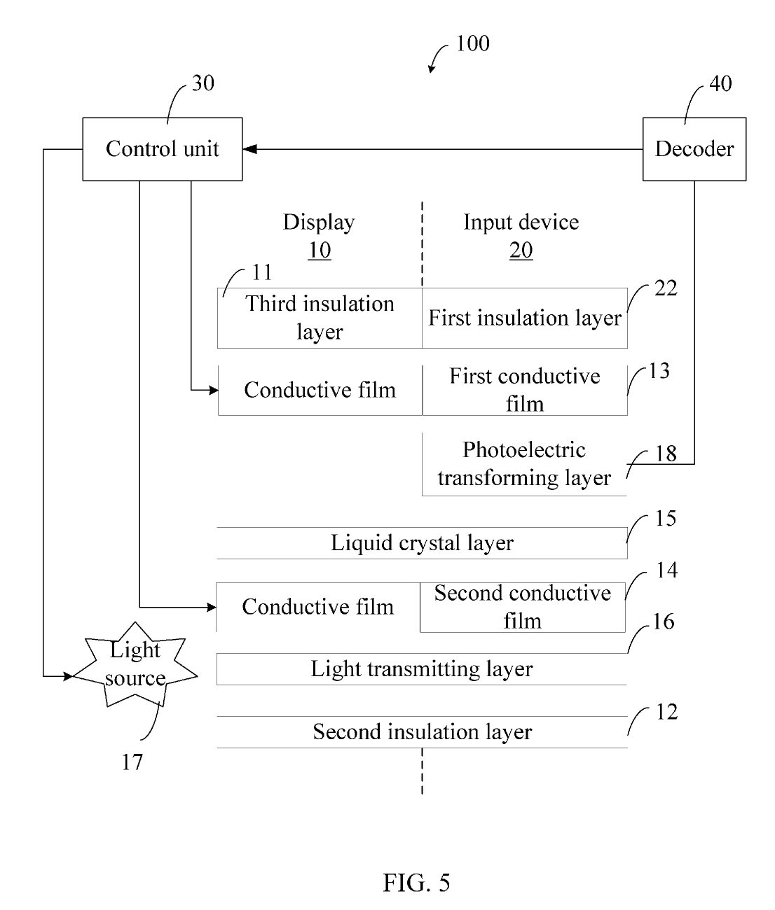

Conventionally, a liquid crystal display (LCD) also has two conductive films/layers similar to the first and second conductive films 13, 14, and a liquid crystal layer similar to the liquid crystal layer 15. Thus, when the display 10 is the LCD display, the display 10 and the input device 20, the two conductive films/layers, and the liquid crystal layer of the display 10 may be integrated together. The LCD display may also have one or more light source and a light emitting transmitting layer for backlighting. Thus the display 10 and the input device 20 may share the light source 17, and the light transmitting layer 16. The second insulation layer 12 may also be shared by the display 10 and the input device 20 (see FIG. 5). The display 10 may also include a third insulation layer 11 as a protection layer disposed on top of the display 10. As a result, the display 10 and the input device 20 may be integrated together.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An input device comprising:
a key, the key comprising:
a first conductive film;
a second conductive film for cooperating with the first conductive film to generate a first electric field having a first predetermined intensity when the key is pressed;
a light source for emitting light;
a photoelectric transformer for generating a first electric signal when receiving light from the light source; and
a liquid crystal layer for transmitting the light to the photoelectric transformer under influence of the first electric field.

2. The input device as claimed in claim 1, wherein the first conductive film and the second conductive film cooperate to generate a second electric field having a second predetermined intensity when the key is released, the second predetermined intensity is lower than the first predetermined intensity.

3. The input device as claimed in claim 1, further comprising a first insulation layer disposed on top of the key as a touch layer.

4. The input device as claimed in claim 3, wherein the first insulation layer has one or more key identification characters engraved or printed thereon.

5. The input device as claimed in claim 3, wherein the first insulation layer is opaque.

6. The input device as claimed in claim 3, wherein the key further comprises a second insulation layer disposed at the bottom of the key.

7. The input device as claimed in claim 1, wherein the key further comprises at least one light conduit for transmitting light emitted by the light source to the liquid crystal layer.

8. The input device as claimed in claim 1, wherein the photoelectric transformer comprises a phototransistor, an emitter of the phototransistor is grounded, a collector of the phototransistor is connected to a power supply via a resistor, the collector is an output terminal of the photoelectric transformer.

9. The input device as claimed in claim 4, wherein position of the one or more key identification characters coincides with position of the photoelectric transformer.

10. The input device as claimed in claim 1, wherein the liquid crystal layer is further configured for displaying key identification character(s), position of the key identification character(s) and position of the photoelectric transformer are staggered.

11. An input device comprising:
a light source for emitting light; and
a plurality of keys, at least one of the plurality of keys comprising:
a first conductive film;
a second conductive film for cooperating with the first conductive film to generate a first electric field having a first predetermined intensity when the key is pressed;
one or more light conduits for transmitting light emitted by the light source;
a photoelectric transformer for generating a first electric signal when receiving the light from the light source via the one or more light conduits; and
a liquid crystal layer for transmitting light from the one or more light conduits to the photoelectric transformer under influence of the first electric field.

12. The input device as claimed in claim 11, further comprising a decoder for receiving the first electric signal and generating a second electric signal corresponding to one of the plurality of keys which is pressed.

13. The input device as claimed in claim 11, wherein the first conductive film and the second conductive film cooperate to generate a second electric field having a second predetermined intensity when the key is not pressed, the second predetermined intensity is lower than the first predetermined intensity.

14. The input device as claimed in claim 11, wherein the at least one of the plurality of keys further comprises a first insulation layer disposed on top of each of the plurality of keys as a touch layer.

15. The input device as claimed in claim 11, wherein the photoelectric transformer is a phototransistor, an emitter of the phototransistor is grounded, a collector of the phototransistor is connected to a power supply via a resistor, the collector is also connected to the decoder.

16. An electronic device, comprising:
an input device, the input device comprising:
a light source for emitting light;
a plurality of keys, at least one of the plurality of keys comprising:
a first conductive film;
a second conductive film for cooperating with the first conductive film to generate a first electric field having a first predetermined intensity when the key is pressed;
one or more light conduits for transmitting light emitted by the light source;
a photoelectric transformer for generating a first electric signal when receiving the light from the light source via the one or more light conduits; and
a liquid crystal layer for transmitting light from the one or more light conduits to the photoelectric transformer under influence of the first electric field; and
a decoder for receiving the first electric signal and generating a second electric signal corresponding to one of the plurality of keys which is pressed.

17. The electronic device as claimed in claim 16, wherein the first conductive film and the second conductive film cooperate to generate a second electric field having a second predetermined intensity when none of the plurality of keys is pressed, the second predetermined intensity is lower than the first predetermined intensity, and cannot influence the liquid crystal layer.

18. The electronic device as claimed in claim 16, wherein the input device further comprises a first insulation layer disposed on top of the at least one of the plurality of keys as a touch layer.
